(19) United States
(12) Patent Application Publication
(10) Pub. No.: US 2002/0118096 A1
(43) Pub. Date: Aug. 29, 2002

(54) Building security system

(76) Inventors: Hector Hoyos, Guaynabo, PR (US); Alex Rivera, San Juan, PR (US); Miguel Berrios, Guaynabo, PR (US); Hector Vargas, Juana Diaz, PR (US)

Correspondence Address: Patent Law Offices of, Heath W. Hoglund, 391 Juan A. Davila Street, San Juan, PR, 00918, US

(21) Appl. No.: 09/867,232

(22) Filed: May 29, 2001

Related U.S. Application Data
(60) Provisional application No. 60/207,683, filed on May 26, 2000.
(60) Provisional application No. 60/207,562, filed on May 26, 2000.

(51) Int. Cl. H04Q 1/00; G05B 19/00

(52) U.S. Cl. 340/5.52

(57) ABSTRACT

A security system includes a central computer connected through a network to a plurality of remote computers. A database of user information is created at the central computer and copied to the remote computers. The remote computers include user interfaces for the collection of user information such a fingerprint and a user ID. When a user provides this information, the remote computer compares it to the database. If a match is generated, the remote computer authorizes access through an associated passageway. The security system can also be used to monitor user access times and to present messages to users.

### FIELD OF THE INVENTION

The present invention relates generally to a computerized security system used to restrict access to or within a building or property.

### DESCRIPTION OF RELATED ART

Security systems are widely used to control entry to a building or a property. Where only a few people are permitted access to a property, e.g. a home, the security system may be relatively simple, consisting of a lock with an associated key on every door. Although this security system is acceptable for many homes, it is not suitable for many commercial applications for a number of reasons.

First, as the number of people who require access to a property increases, the security risks generally increase as well. For example, business that use a simple lock and associated key on every door typically provide keys to a selected group of employees. Invariably, someone in that group eventually loses a key and that loss poses a potential security hazard. Moreover, businesses typically experience some employee turnover. Although an employee typically returns any building keys upon the termination of his or her employment, this administrative burden is sometimes overlooked and poses an additional security risk.

Second, many commercial buildings require more careful monitoring of the persons who have entered a particular building. For example, a warehouse that is used to store valuable goods will require carefully restricted access. In such applications, a simple lock and associated key for every door is generally inadequate.

In other settings, especially academic or commercial research settings, access may be restricted to prevent loss of trade secret information. In such applications, a property may be divided into different areas. To minimize the risk of loss, employees may be granted access to the different areas only on an as needed basis. Thus, a person may have access to a main entrance and a specific area but not to the entire property. Although a key and lock security system may be used for these types of settings, the administrative burden of monitoring who has copies of the various keys quickly becomes impractical. Likewise, the cost of providing a security guard at every entrance is not economically or administratively feasible for most applications.

Accordingly, a number of computerized security systems have been implemented to reduce the administrative burden and to reduce the risk of unauthorized entry into a building or property. For example, U.S. Pat. No. 4,210,899, titled “Fingerprint-Based Access Control and Identification Apparatus,” issued to Swonger et al. on Jul. 1, 1980, discloses a security system that uses a human fingerprint to control access. U.S. Pat. No. 4,395,628, titled “Access Security Control,” issued to Silverman et al. on Jul. 26, 1983, discloses another security system that uses a control card to control access. U.S. Pat. No. 5,608,387, titled “Personal Identification Device and Access Control Systems,” issued to Davies on Mar. 4, 1997, discloses still another security system that uses human recognition of a complex image to control access. Each of the above-listed patents are incorporated herein by reference.

### SUMMARY OF THE INVENTION

According to one aspect of the invention a security system includes a first and second unit. The first unit generates a database of biometric features each associated with a specific person. To create this database, the first unit uses an input that generates an electronic representation of a biometric feature. The electronic representation is received by a computer processor in the first unit. This computer processor saves the first electronic representation of the biometric feature in the database of biometric features. The second unit is coupled with the first unit by a network. The second unit is situated near an access point and is configured to control the access point based upon the database of biometric features. The access point is controlled by activating or deactivating an access device such as a locking solenoid. As with the first unit, the second unit also includes an input that generates a representation of a biometric feature. The second unit also includes a computer processor. This computer processor receives the representation of the biometric feature and compares it with the database of biometric features. If this comparison generates a match, the computer process activates (or deactivates) the access device to open the associated access point.

According to a further aspect of the invention, the security system also includes a third unit operationally coupled with the second unit. The second and third unit are situated on opposite sides of the access point, such as a door. The third unit includes an input configured to generate an electronic representation of the biometric feature. This input is operationally coupled with the computer processor of the second unit. When this computer processor receives an electronic representation of the biometric feature from the input device of the third unit it compares it with the database of biometric features to determine whether the comparison generates a match. If so, it opens the access point.

According to a further aspect of the invention, the input devices are fingerprint sensors, and the biometric feature is a person's index or thumb print.

According to a further aspect of the invention, the input devices are video cameras, and the biometric feature is a person's face.

According to a further aspect of the invention, the security system also includes an access device, such as a locking solenoid.

According to another aspect of the invention, a security system includes an administration unit and a control unit. The administration unit is configured to generate a database of biometric features and user identifications (ID's) (and/or password) each associated with a specific person. The administration unit includes one input configured to capture a representation of a biometric feature and to generate an electronic representation of the biometric feature. The administration unit also includes another input configured to receive a user ID. The administration unit further includes a computer processor operationally coupled with the inputs and configured to save the electronic representation of the biometric feature and the user ID in the database. In the database, the user ID and the biometric feature are associated. The control unit is operationally coupled with the administration unit and configured to control an access device. The control unit includes an input configured to capture a representation of the biometric feature and to generate an electronic representation of the biometric feature. The control unit includes another input configured to receive a character string. The control unit further includes a computer processor operationally coupled with the inputs and with the database. The computer processor compares the electronic representation of the biometric feature with the database and determines whether the comparison generates a biometric match. The comparison is made with the biometric feature associated with the user's ID.

According to a further aspect of the invention, the security system also includes an auxiliary unit operationally coupled with the control unit. The auxiliary unit and the control unit are situated on opposite sides of an access point. The auxiliary unit includes an input configured to capture a representation of the biometric feature and to generate an electronic representation of the biometric feature. The auxiliary input also includes another input configured to receive a character string. These inputs are are operationally coupled with the computer processor of the control unit. The computer processor of the control unit is configured to compare this electronic representation of the biometric feature with the database to determine whether the comparison generates a biometric match. The comparison is made with the biometric feature associated with the character string. If the database does not include a matching character string, the comparison of the biometric feature is unnecessary.

According to a further aspect of the invention the biometric feature is a fingerprint.

According to a further aspect of the invention, the biometric feature is a human face.

According to a further aspect of the invention, the security system includes an electric circuit connected with the control unit and configured to control a magnetic field.

According to a further aspect of the invention, the security system includes a number of control units each operationally coupled with the administration unit and configured to control an access device. The security system also includes a number of auxiliary units each operationally coupled with one of the plurality of control units. The auxiliary unit and the control unit pairs are situated on opposite sides of an access point.

According to another aspect of the invention, a security system is especially suited for controlling access within a building having a limited number of access points each having an interior side and an exterior side. The security system includes locking mechanism, interior and exterior user interfaces, a computer server and a number of remote computers. The locking mechanisms are each associated with one access point and are configured to prevent passage through the access point in a closed position and to permit passage through the access point in an open position. The interior user interfaces are each associated with one access point and configured to generate a representation of a biometric feature and to receive a user ID from a user. The exterior user interfaces are each associated with one access point and configured to generate a representation of a biometric feature and to receive a user ID from a user. The computer server has a database of user information including a plurality of records each of which includes a representation of a biometric feature, access privileges, and a user identification. The local computers are each associated with one access point and operationally coupled with the associated interior user interface and the exterior user interface and operationally coupled through a network connection to the computer server. Each of the local computers controls the locking mechanism associated with the same access point. Each of the local computers are positioned on an interior side of the associated access point.

According to a further aspect of the invention, each of the plurality of interior user interfaces includes a touch screen and a fingerprint sensor. The touch screen is configured to present messages to a user and to receive a user ID from the user. The fingerprint sensor is configured to generate the representation of the biometric feature.

According to a further aspect of the invention, the exterior user interfaces include a keypad and a fingerprint sensor. The keypad is configured to receive the ID from the user. The fingerprint sensor is configured to generate the representation of the biometric feature.

According to a further aspect of the invention, the database includes time records each associated with a user identification. The time records detail the time in and time out of each user.

According to a further aspect of the invention, each local computer includes a database of user information including a record for each authorized user that includes a representation of a biometric feature and an ID. The user information is copied from the computer server.

According to a further aspect of the invention, each local computer is configured to receive time in commands and time out commands from a user. These are transmitted to the computer server along with a user identification.

According to another aspect of the invention, the operation of a security system includes establishing a central database of user information including records each having a representation of a biometric feature, a user ID and access privileges for each user. The biometric feature is saved as an indirect representation of a fingerprint that prevents direct recovery of the fingerprint image. The user information is transferred from the central computer to a plurality of remote computers each having a display, a keypad interface and a biometric sensor. One of the remote computers receives a representation of a biometric feature such as a fingerprint and a user ID such as a numeric string from a user and compares that information to the local user information. If that comparison generates a match, the remote computer unlocks an access mechanism that allows the user to pass.

According to a further aspect of the invention, a message for a user is entered and associated with one of the records. When the user generates a match for that record, the message is presented to the user.

According to a further aspect of the invention, the remote computer transfers an access time to the central computer contemporaneous with the unlocking of the access mechanism.

According to a further aspect of the invention, a restricted 'set of access times and access points for each user are established. These vary by user.

According to a further aspect of the invention, the remote computer determines access privileges after generating a match with the biometric feature and the user ID. The remote computer unlocks the access mechanism only if the user has access privileges.

### BRIEF DESCRIPTION OF THE DRAWINGS

FIG. 1 is a diagram showing one preferred security system including a network that connects a central server with a plurality of remote computers. The security system also includes a plurality of user interfaces each connected with one of the remote computers.

FIG. 2 is a diagram of another preferred security system including a pair of user interfaces that control four access points.

FIG. 3 is a diagram of another preferred security system including a pair of user interfaces that control a single access point.

FIG. 4 is diagram of another preferred security system including a user interface and an access point.

FIG. 5 is a perspective view of one preferred user interface.

FIG. 6 is a perspective view of one preferred remote computer including a user interface.

FIG. 7 is a block diagram of the components of a remote computer including a user interface and connections to a second user interface.

FIG. 8A is a flow chart showing one preferred method of configuring a database of user information.

FIG. 8B is a flow chart showing one preferred method of entering a message for deliver to a system user.

FIG. 9 is a block diagram of one preferred data structure saved on a remote computer for determining whether a user has access privileges.

FIG. 10 is a flow chart showing one preferred method of determining wheter a user has access privileges.

### DETAILED DESCRIPTION OF THE PREFERRED EMBODIMENTS

The preferred embodiments described below are related to U.S. patent application Ser. No. ______/______ ,titled “Security System Database Management,” to Hoyos et al., filed on May ______, 2001, which is incorporated herein by reference.

In one preferred embodiment a building includes a number of doors through which a person may enter. A control device is provided at each such door. The control device includes an electrical control for a locking mechanism that restricts the opening of the associated door. The control device also includes a user interface that includes both a touch screen and a fingerprint sensor. A user may gain entry to the building by placing his or her finger on a fingerprint sensor and keying a unique identifier. The control device includes a computer having software necessary to perform all related control functions.

In some applications, both the entry and the exit from a building will be controlled. In such cases an access device may be provided on the other side of the door. The access device connects with the locking mechanism. To exit the building, or secured area, a user may place his or her finger on a fingerprint sensor and key the unique identifier. The access device does not include a computer and necessary software to perform this functionality, but instead connects with the control device. The control device provides the necessary support. This helps reduce the overall system cost and complexity by reducing the number of computers required for the various access points.

The control device includes a database of user information that is used in determining whether to allow a person access. That database is generated at another central computer. The central computer connects to each of the control devices. The central computer is used to generate the database of user information. It is also used to configure the control devices. For example, the central computer is used to configure the database of user information to specify the hours during which a particular user may gain access to a particular door or to the entire building. The central computer connects with the remote devices through an Ethernet network.

According to other aspects of the invention, a preferred embodiment of a security system includes a server computer coupled to a plurality of remote computers configured to control access points. The server is used to create a database of user information including a representation of a biometric feature such as a fingerprint and a user ID. This information is accessed by the remote computers. When a user attempts to pass through an access point, the user must present his or her fingerprint to a scanner. The remote computer compares an electronic representation of the fingerprint to the database of the user information. In addition, the user enters an ID. The comparison of the fingerprint is made with the record associated with the ID. If this comparison generates a match, then the remote computer permits the user to pass through the associated access point.

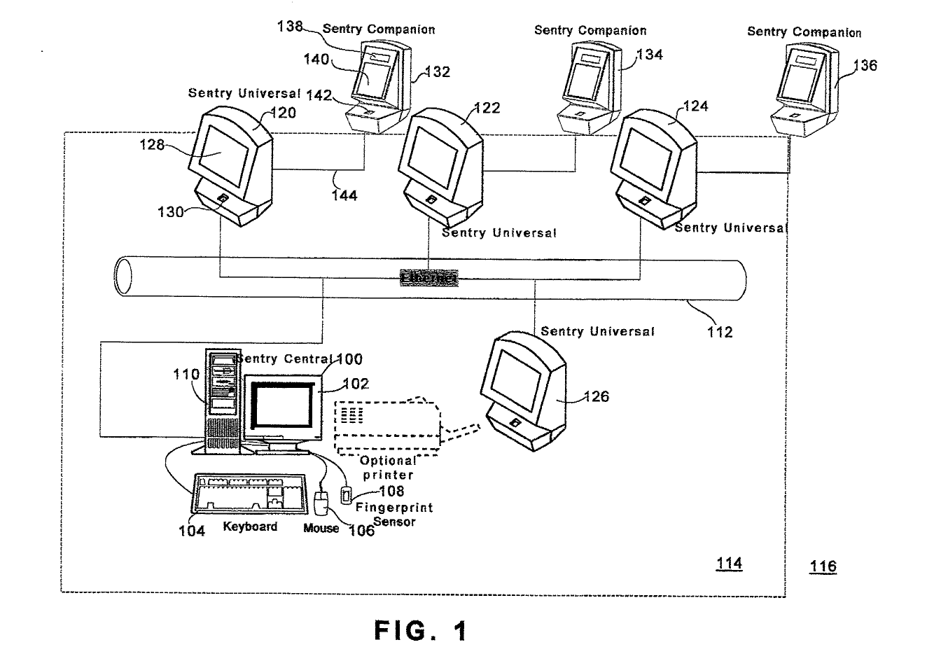

Turning to FIG. 1, one preferred embodiment of a security system is described. The system includes a central computer 100. The central computer 100 includes a display 102, a keyboard 104, a mouse 106 and a fingerprint sensor 108. The central computer 100 also includes a processor and a memory configured to store a database of user information. The processor and memory are housed within enclosure 110 and operationally coupled with the other components of the central computer 100. Preferably, the central computer 100 operates using Windows NT, though other operating systems configured to support a network could also be used.

The central computer 100 connects through a network 112 to a plurality of remote computers 120, 122, 124 and 126. The remote computers 120, 122, 124 and 126 are positioned within the interior of an access area 114. Access to this area is restricted to authorized users. Remote computer 120 includes a processor and memory. Remote computer 120 also includes a touch screen 128 and a fingerprint sensor 130. Further the state of an external circuit controlling the associated access point. This permits the user to pass through the access point.

By retaining a local database of user information, the system reduces downtime due to any network failures. For example, if for any reason central computer 100 crashes or becomes unavailable, remote computer 120 is still able to control access based upon a copy of the user database that is retained locally.

Remote computers 122, 124 and 126 function in the same manner as remote computer 120. Remote computers 120, 122 and 124 each connect with a user interface 132, 134 and 136, respectively through a communication channel. Preferably communication channel 144 is made as an RS-422 and a parallel connection. User interfaces 132, 134 and 136 are positioned in an unsecured area 116 surrounding access area 114.

User interface 132 includes a display 138, a keypad 140 and a fingerprint sensor 142. Preferably, user interface 132 does not include a computer processor or associated memory. This background support is provided by remote computer 120. This configuration helps to reduce system cost and complexity by reducing the total number of computers.

User interface 132 functions, in many respects, in the same manner as computer 120 itself. As a user approaches, display 138 prompts the user to present his or her finger on fingerprint sensor 142. An electronic representation is generated and passed through communication channel 144 to remote computer 120. Remote computer 120 pre-processes the representation. Meanwhile, remote computer 120 commands user interface 132 to present a message to the user requesting entry of the user's ID. The user then enters an ID through keypad 140. The ID is transmitted through communication channel 144 to remote computer 120. The pre-processed representation of a user's fingerprint is then compared with the appropriate database entry. If it matches, the remote computer 120 changes the state of a circuit that controls the associated access point. This permits the user to pass through the associated access point. Otherwise, remote computer 120 commands user interface 132 to present a message on display 138 that the fingerprint did not match. The user may then re-attempt the access process.

Remote computer 122 and user interface 134 operate in the same manner as remote computer 120 and user interface 132. Likewise, remote computer 124 and user interface 136 operate in the same manner as remote computer 120 and user interface 132. Remote computer 126 functions in the same manner as remote computer 120, except that it is not associated with another user interface. In the configuration shown, remote computer 126 would control an exit-only access point since it is located within access area 114.

According to another aspect of the invention, the security system is used to monitor time in and time out for system users. In operation, the remote computers 120, 122, 124 and 126 can transmit to central computer 100 the time in and time out of each user. A database for this information is maintained on the central computer 100. When the remote computer recognizes a user by generating a feature and user ID match, that information is sent through the network 112 to central computer 100. The system administrator may generate reports or transfer this data to other applications.

In an alternative preferred embodiment, a particular user may be given access permission only to certain access points. In this configuration, the respective remote computer will also check for access privileges. If the user does not have access privileges for the associated access point, then the remote computer will not permit access through that access point. For example, a user may have access privileges for the access point associated with remote computer 120 and user interface 132, but not for any other access point. In this configuration, when the user is properly identified at the access point then he or she will be permitted to pass through the access point. However, when the user attempts to access any other access point, the user will be advised that he or she does not have privileges for that access point.

In yet another preferred embodiment all of the remote computers and user interfaces are positioned outside the access area 114, in unsecured area 116. In this configuration, each remote computer and each user interface is used to control a different access point. Once a user gains access to and enters access area 114, then the user may exit by operating a simple control switch. The control switch automatically permits exit.

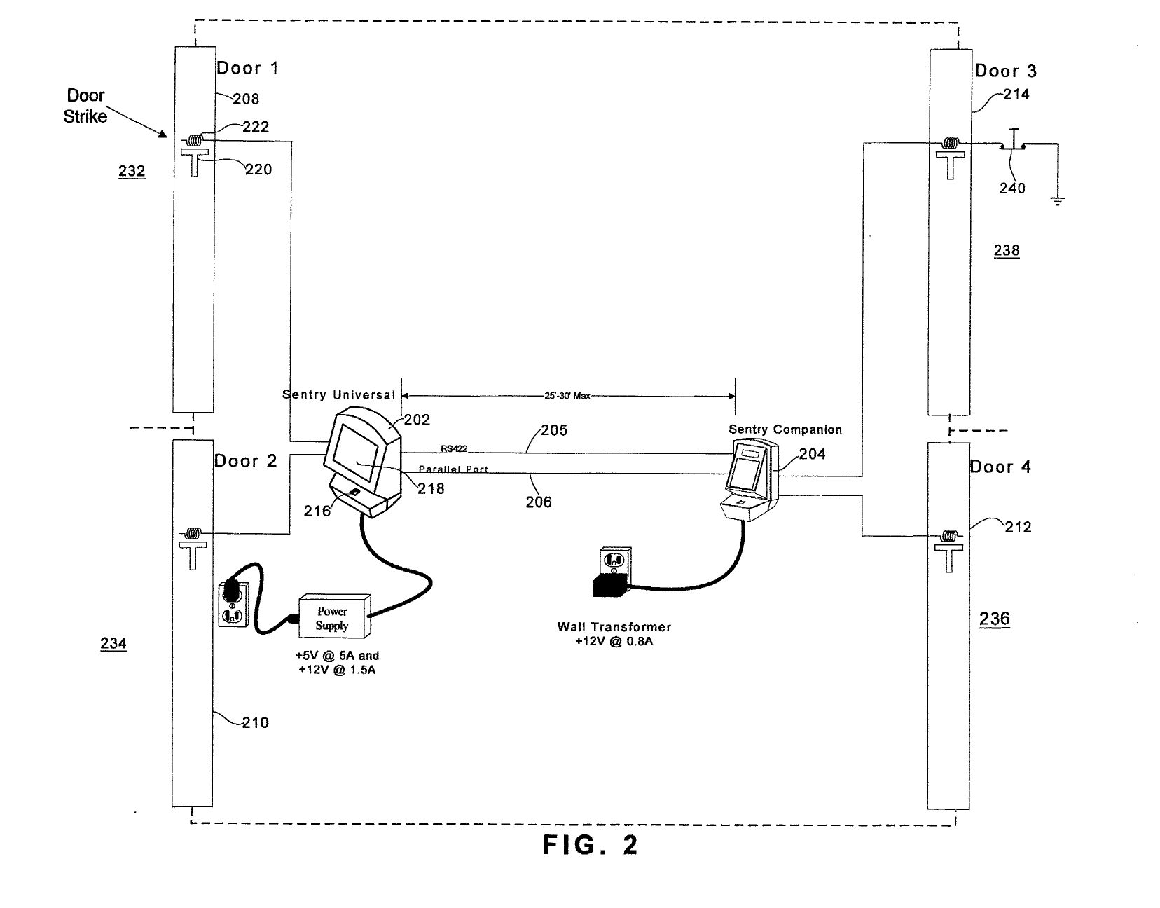

Turning to FIG. 2, another preferred configuration of the security system is described. Here, a remote computer 202 connects with a user interface 204 through a pair of communications channels 205 and 206. Communication channel 205 is an RS-422 link and communication channel 206 is a parallel port link. By providing both channels, the system effectively increases the data transfer rate between the two user interfaces. Thus user interface 204 is able to transfer more quickly electronic data representing a user's fingerprint. Due to the limitations of the communications link, the remote computer 202 should not be stationed more than approximately twenty five feet from the user interface 204.

As with the remote computers described above with reference to FIG. 1, remote computer 202 maintains a database of user information that it receives from a network server (not shown in FIG. 2). Alternatively, for a simple two-unit system such as is shown in FIG. 2, the user information could be entered directly into remote computer 202 and avoid the need for a network server.

Each of the user interfaces, that is remote computer 202 and user interface 204, control access through two access points. Specifically, remote computer 202 controls access through doors 208 and 210; user interface 204 controls access through doors 212 and 214.

To gain access to door 208 or 210, a user presents his or her finger on a fingerprint sensor 216 and enters an ID through a touch-screen keypad 218 on remote computer 202. If this entry matches a record in the user database, then remote computer 202 prompts the user to select between door 208 and 210. The selection choice is displayed on touch screen 218.

Alternatively, a user may be given access to only one of the doors. In this case, the user is advised as to which door they may enter.

Door 208 is held in a secure position by a magnetic attraction between a ferrous material 220 embedded or attached to the door and an energized inductor 222 that creates a strong magnetic field. That field reaches the ferrous material and effectively binds it in place. If an unauthorized person attempts to open the door, the bond between the magnetic field and the ferrous material prevents such access.

Current through the inductor 222 is controlled by remote computer 202. In a default state, remote computer 202 energizes the inductor 222 so that access through door 208 is controlled. When a user successfully provides a fingerprint and user ID that matches a record in the user database, then remote computer 202 deactivates inductor 222 for a short period of time, preferably five seconds or less. During this time, the user may open the door without limitation by the magnetic field of inductor 222. Door 210 is controlled by remote computer 202 in the same manner.

User interface 204 controls doors 212 and 214 also by energizing a magnetic coil. When energized, the magnetic coil engages the associated door so that access through that door is prevented. After a user presents an authorized fingerprint and ID to user interface 204, the user is prompted to select between the two doors. The user selects one of these options, and the respective coil is deactivated to permit passage through that access point.

In the example of FIG. 2, the connections are shown for illustrative purposes only. In a typical application, the connections between remote computer 202 and doors 208 and 210 are routed through a wall or other hidden enclosure. This prevents tampering with the circuitry and helps to avoid unauthorized access. Preferably, remote computer 202 is securely mounted on a wall directly over a power source. Again, this helps to prevent tampering with the system. Likewise, the connections between remote computer 202 and user interface 204, as well as the connections between user interface 204 and doors 212 and 214 are routed through a wall or other secure enclosure.

The physical configuration shown in FIG. 2 is suitable for use in a building having a central elevator shaft where access to the building is restricted on a floor-by-floor basis. Thus, the system shown in FIG. 2 would be used on one of the upper floors. When a person exits the elevator, they would enter an unsecured area 230 and have the choice of entering one of four wings of that floor. Each one of the doors 208, 210, 212 and 214 control access to one wing or secure area 232, 234, 236 and 238, respectively. The remote computer 202 and the user interface 204 would be mounted on opposite side walls of the elevator lobby so that remote computer 202 is proximate doors 208 and 210, and user interface 204 is proximate doors 212 and 214. A simple access switch is provided on the other side of each of the doors, within the secure area. When a user wishes to exit a wing, the user simply activates the access switch (e.g., switch 240) and the respective coil is deactivated.

The relative positions of the doors and user interfaces is shown for illustrative purposes only. In other embodiments, the doors 208, 210, 212 and 214 could define the access points to an enclosed access area. In this application, the doors would surround the access area. For example, the system shown in FIG. 2 could be used to control access to a room. The remote computer 202 and user interface 204 would be placed outside the room proximate the doors that permit access to the room. Within the access area, simple switches would control exiting through any of the doors.

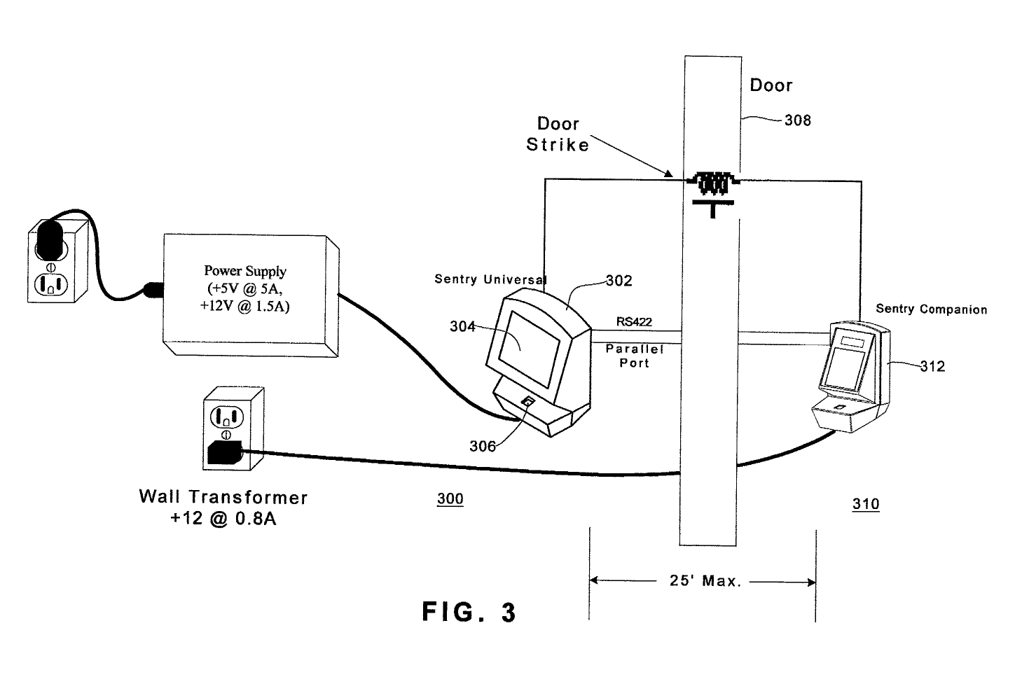

Turning to FIG. 3, another preferred system configuration is described. Here a remote computer 302 having a touch screen interface 304 and fingerprint sensor 306 is positioned within a secure area 300. Remote computer 302 is used to control access to door 308, based upon a representation of a user's fingerprint and an ID. On the opposite side of door 308, in an unsecured area 310, a user interface 312 controls access to the secure area 300. As the above-described system, user interface 312 connects with remote computer 302 through an RS422 and a parallel port link. Preferably, both the remote computer 302 and the user interface 312 are powered from the secure area. This avoids security breaches that may result from an external source. Specifically, the user interface 312 is mounted so that it covers the links to remote computer 302 and so that it covers the source of its power supply.

In this configuration, a user must provide his or her fingerprint and ID both to enter and to leave the secure area. This may be used to monitor access to a building or secure area.

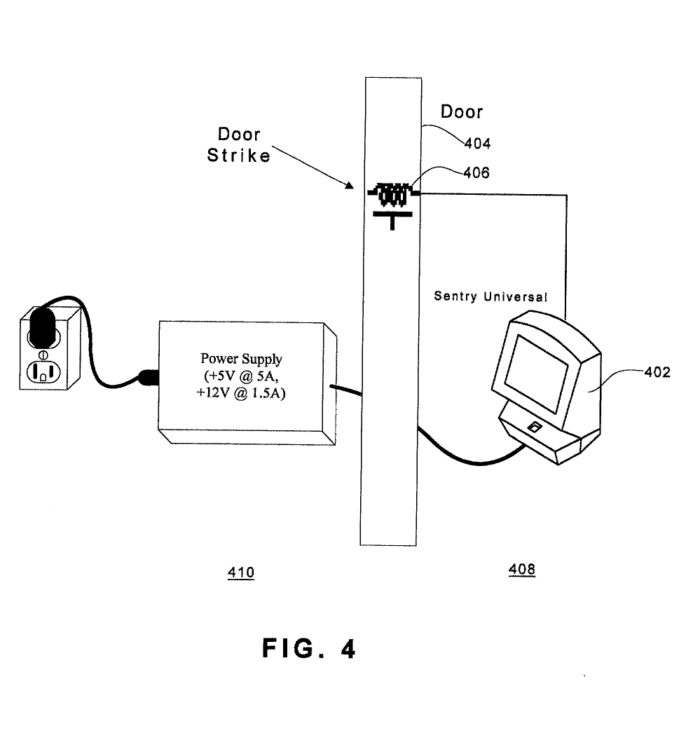

Turning to FIG. 4, yet another preferred system configuration is described. Here, remote computer 402 is positioned adjacent door 404. Remote computer 402 controls access through the door by activating coil 406. In this configuration, remote computer 402 is positioned in unsecured area 408 and controls access to a secure area 410. Here, remote computer 402 is powered from the secure area to minimize the risk of tampering with the power supply.

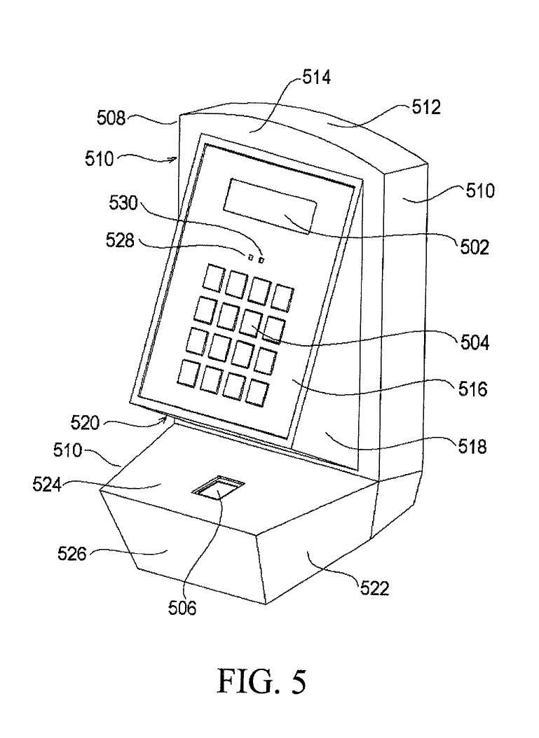

Turning to FIG. 5, one preferred user interface that does not include a computer processor will be described. The user interface includes a display 502, a keypad 504 and a fingerprint sensor 506. Broadly, the structure of the user interface can be divided into two portions, an upper body 508 and a lower tray 510. The upper body 508 is configured to attach to a wall along its back side and to present the display 502 and keypad 504 along its front side.

More specifically, upper body 508 includes rectangular side walls 510 that extend vertically along its left and right sides. Side walls 510 meet a curved upper wall 512. The front sides of the side walls 510 and the curved upper wall 512 meet a substantially flat front 514. A slanted face 516 extends from front 514 as a rectangular surface. Slanted face 516 includes display 502 and keypad 504. Slanted face 516 joins front 514 along its sides by triangular walls 518. These extend substantially perpendicular from front 514. Slanted face 516 joins front 514 along its bottom by a rectangular wall 520 that extends at an upward angle from front 514.

Preferably, the user interface is mounted at a height of approximately four feet. At this level an average user will view the display 502 and keypad 504 from above. The gradual slant provided along face 516 provides a more direct line of sight for these components.

Turning to the lower tray 510, it joins the upper body along three surfaces. Specifically, the lower tray 510 includes left (not visible in view shown) and right side walls 522, each shaped in the form of a pair of trapeziums. The back portion of the left and right side walls 522 join the side walls 510 on their respective side. Lower tray 510 also includes an upper surface 524 shaped substantially as a trapezoid. The rearmost parallel side of the upper surface 524 joins the bottom side of front 514. The right and left, non-parallel sides join the right and left side walls 522, respectively. Another trapezoidal surface defines a front 526 of the lower tray. The upper parallel side of front 526 joins the upper surface 524 along its front-most parallel side. The non-parallel sides of front 526 join the front sides of side walls 522.

The fingerprint sensor 506 is positioned along the front of upper surface 524. This portion extends beyond slanted face 516 so that a user can easily locate the fingerprint sensor 506 and place his or her finger upon it. Face 516 also includes a red light 528 and a green light 530. In a default state, the red light 528 is lit to indicate that a valid fingerprint is not being detected by the fingerprint sensor 506. When a user places his or her finger on the fingerprint sensor 506, and a positive representation is detected, the red light 528 is extinguished and green light 530 is lit.

Keypad 504 includes the numerical digits as well as the * and # keys, which may be used as part of a valid user ID. In addition, keypad 504 includes an in and an out key. In addition to controlling the access to a particular area, the system may also be used to monitor the attendance of employees. When used for this purpose, an employee may elect to stay within a restricted area even though he or she is not currently working. To log out or back in, an employee may provide positive identification including a fingerprint and ID, then hit the in or out key to log in or out, respectively.

Finally, keypad 504 includes a clear and an enter key. When entering an ID, a user may press the clear key to clear an entered character and may press the enter key when they have finished entering their ID.

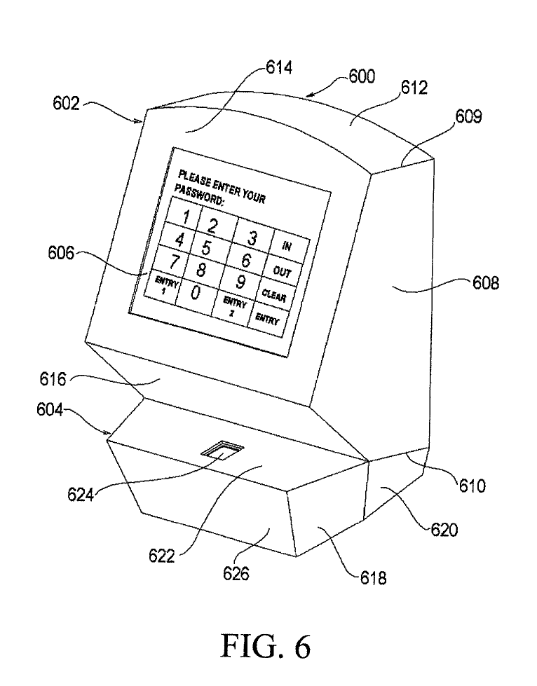

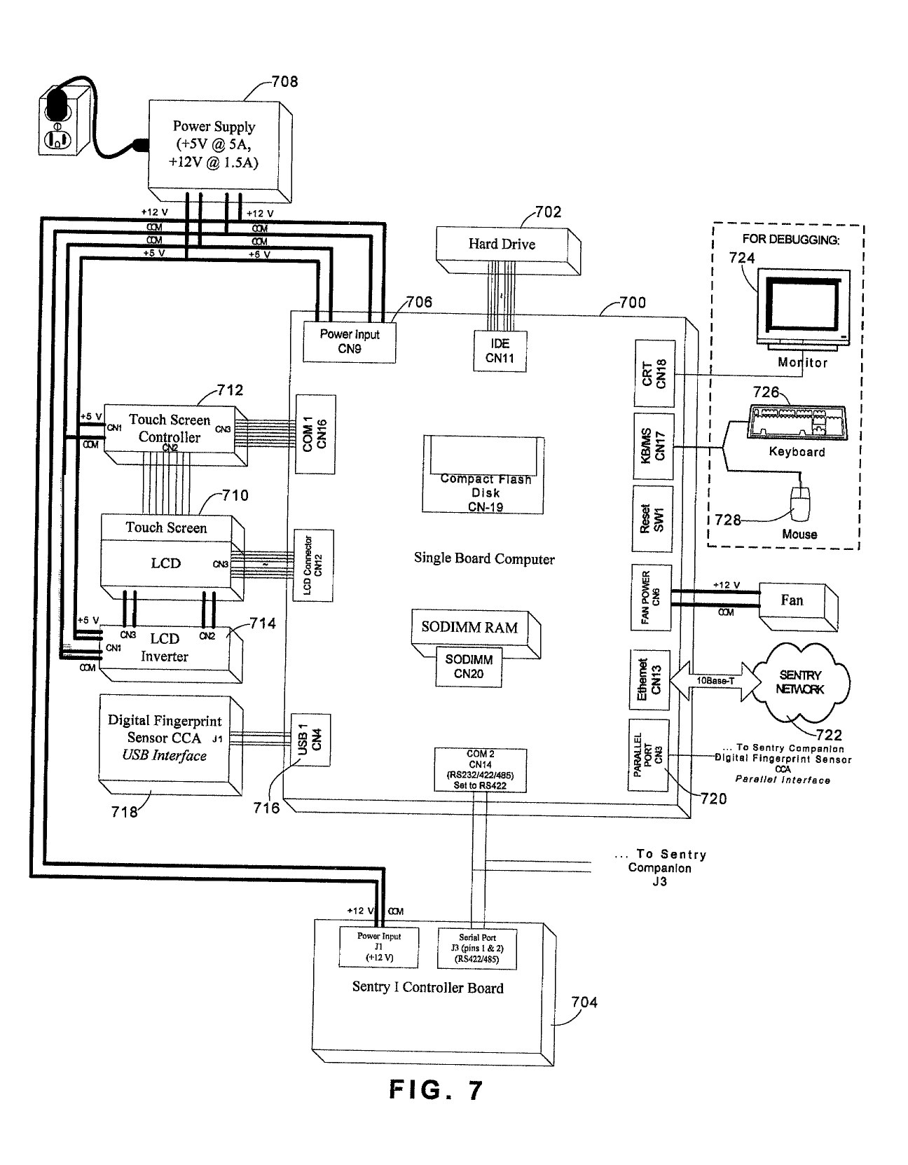

Turning to FIG. 6, one preferred enclosure 600 for a remote computer is described. Broadly, the shape of this enclosure is similar to the shape of the user interface described in FIG. 5. Nonetheless, the upper body of the enclosure is substantially deeper to accommodate a single-board computer and associated hardware. The structure of the enclosure will now be described; the configuration of the interior hardware will be described below with reference to FIG. 7.

Broadly, enclosure 600 also can be divided into two portions, an upper body 602 and a lower tray 604, which are symmetric about a central vertical plane. The upper body 602 is configured to attach to a wall along its back side and to present a touch screen 606.

More specifically, upper body 602 includes pentagonal side wall 608. The base of that pentagon is configured to meet a supporting wall. The side edges 609 and 610 of the pentagon extend substantially perpendicular from the base so that the upper side edge 609 and a lower side edge 610 of the pentagon are substantially parallel. The upper side edge 609 meets a curved top 612. The opposite side wall of enclosure 600 is formed as a mirror image of side wall 608.

The upper body 602 also includes a. substantially flat front face 614, which defines a square aperture configured to present touch screen 606 to a user. Front face 614 joins curved top 612 along a curved edge. The side edges of front face 614 are parallel and join the upper of the remaining edges of side wall 608. This places front face 614 at an upward facing slant. Preferably, enclosure 600 is mounted at a height of approximately four feet. At this level an average user will view the touch screen 606 from above. The gradual slant provided along front face 614 provides a more direct line of sight for these components.

The upper body 602 further includes a bottom face 616, which joins front face 614 along its bottom edge and side wall 608 along its remaining side. This places bottom face 616 at a downward facing slant, which defines a recess for the lower tray 604.

Turning to the lower tray 604, it joins the upper body along three surfaces. Specifically, the lower tray 604 consists of a pair of side walls each of which are formed by a pair of quadrilaterals 618 and 620. The top of rear quadrilateral 620 joins side wall 608. The top of front quadrilateral 618 joins a sensor table 622. A front wall 626 having a rectangular shape joins sensor table 622 along its top edge and the front edge of quadrilateral 618 along its side.

The sensor table 622 defines a rectangular aperture that permits a user to place his or her finger on a sensor 624. The aperture is positioned near the front wall 626. This recess defined below bottom face 616 provides clear line of sight for most users when the enclosure 600 is positioned as described above.

Turning to FIG. 7, one preferred embodiment of a remote computer will be described. The remote computer is housed entirely within the enclosure 600 of FIG. 6. Broadly, it includes a standard single-board computer 700, a hard drive 702 and a controller 704. The single-board computer 700 is commercially available and includes a power input 706 configured to receive standard voltages from an external power supply 708. The power supply 708 also powers other components as shown.

The single-board computer 700 also includes an LCD interface configured to drive an LCD display 710. The LCD display includes a touch screen configured to receive a response from a user. The touch screen interfaces with the single-board computer 700 through a controller 712. The controller 712 connects through a standard COM port.

To operate the touch screen, single-board computer 700 passes commands to LCD display 710. Based upon these commands, LCD display 710 generates an image. To present a keypad interface, single-board computer passes commands that map the keypad image to LCD display 710. The display is back illuminated by an inverter 714.

The LCD display 710 senses a user's touch on the LCD display 710. The associated coordinates are mapped through a touch screen controller 712 and provided to the single-board computer 700. Using the same mapping relationship as was used to display the keypad, the commands received through controller are mapped to the respective key (i.e., a “1,” a “2,” etc.).

Single-board computer 700 also includes a USB interface 716. This is used to connect with a digital fingerprint sensor 718. When a user places his or her finger on the fingerprint sensor 718, it generates a digital representation

First, an administrator gains access to the user database. Access to this database is restricted by user ID and biometric identification so that changes can be made only by the authorized administrator(s). After the administrator gains access to the database, he or she selects a new user option. At step 802, the administrator enters the name of the new user. Then, at step 804, the administrator enters access privileges for that user. During system set up, a database of access points is established. Each access point is given a name or other identifier. The user's access privileges are established by selecting the access points through which the user may pass. In addition, the times during which a user may enter an area may be restricted. The system administrator may select from a list of default access periods or create a custom access record for each access point to which the user is given privileges. The default access privileges would include a business hours option (i.e., Monday-Friday; 7 a.m.-6 p.m.) and an executive option (i.e., continuous access).

After establishing a user's access privileges, the administrator must also establish a database entry that includes a representation of the user's fingerprint and may include an optional user ID. At step 806, the administrator arranges for the user to place his or her finger on a fingerprint sensor associated with the central server. The administrator then captures six samples of the user's fingerprint. These are made by placing the user's finger on the fingerprint sensor, capturing the electronic image, then asking the user to remove his or her finger. The process is repeated to ensure that an accurate and complete representation is obtained. The administrator then asks the user to enter a numerical user ID. This is repeated once to ensure that the user correctly entered the user ID. The second entry is compared with the first. If these do not match, the user is asked to repeat the process.

For privacy reasons, the fingerprint data is transformed into an indirect representation. This indirect representation is saved in the database rather than an actual map of the topography of the user's fingerprint. This helps to reduce privacy concerns associated with saving such personal data on a computer network.

After receiving the completed set of user data, the central server saves the information in a user database at step 808. In operation, the central server will receive time in and time out information from remote computers. This information also is saved in the user database. The administrator may access this data to create access and time in and time out reports.

After updating the user database, the central server transfers the new user data to the remote computers at step 810. The remote computers use this information to determine whether to permit a user to pass through an access point.

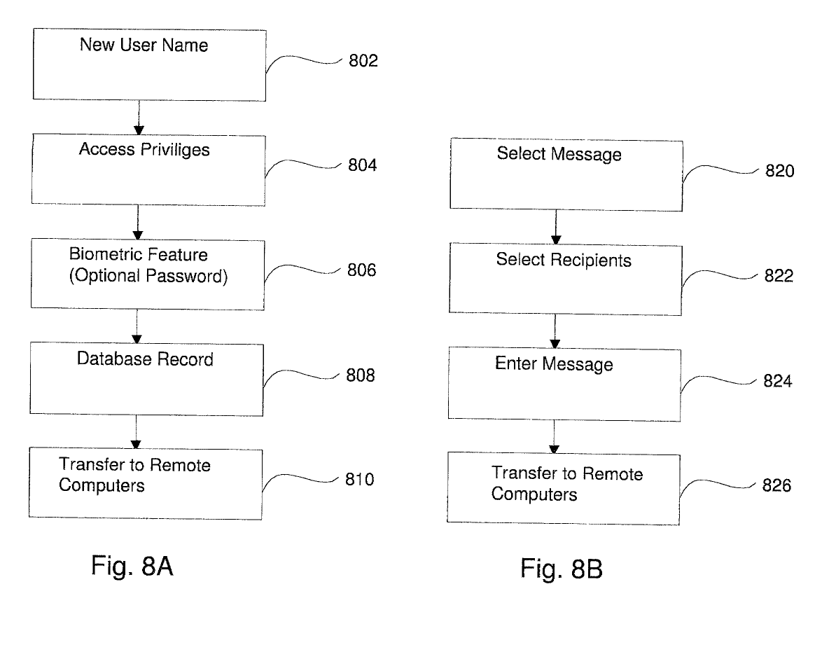

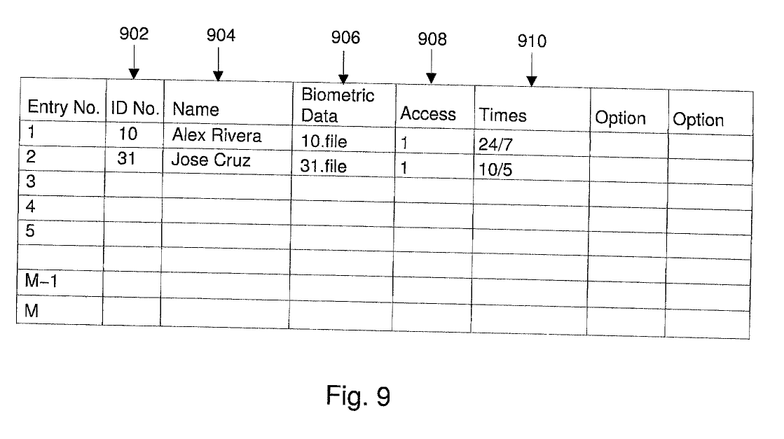

In addition to creating the user database, the administrator can also use the central server to enter messages to an existing user. This process is described with reference to FIG. 8B. Beginning at step 820, the administrator selects a message option. The central server then presents a list of users and groups. At step 822, the administrator selects from this list the intended recipients of the subject message. At step 824, the administrator enters access point, the user's name and a welcome message may be displayed.

The biometric data field 906 is used to store a representation of the user's fingerprint. These fields are accessed when comparing a received fingerprint to the user database. If the received fingerprint matches one of those in the database, the user is likely an authorized system user.

The access field 908 is used to determine whether the user has privileges for the associated access point. Even though a particular user is authorized on the security system, that user may be restricted to certain areas and certain access points. Each remote computer is loaded with an indicator as to whether a user is authorized for the associated access point. The access field is a simple binary field. If authorized the field is set; if not it is cleared.

Finally, the time field 910 identifies the times during which the associated user is authorized for the associated access point. For example, this field could be set to 7 a.m. to 6 p.m. With this setting, the remote computer compares the current time against the time field 912. If the current time falls within this range, the associated user has access privileges, otherwise not. In another example, the field could be set to 24 hour access. This permits the user access at any time.

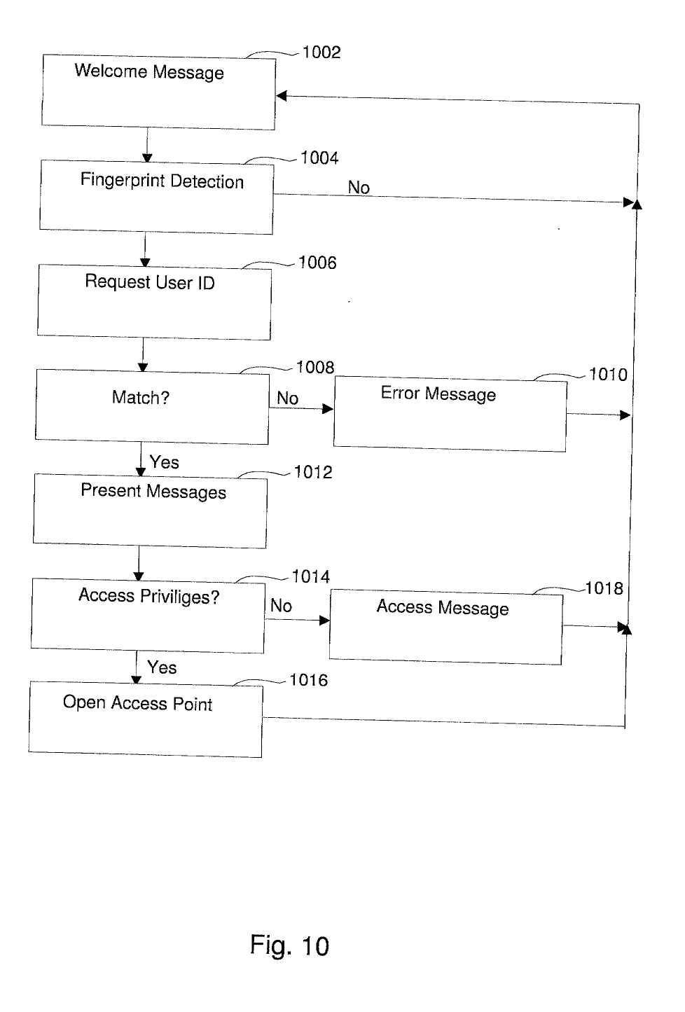

Turning to FIG. 10, one preferred process of permitting access by a remote computer will be described. After establishing a database of user information at a central server, user records are transferred to the remote computer. These records are used by the remote computer in determining whether to permit access to a particular user. As described above, the remote computer may be used in conjunction with a touch screen interface and fingerprint sensor. In addition, it may be connected with an external display, keypad and fingerprint sensor on an auxiliary user interface.

Beginning at step 1002, the remote computer presents a welcome message that advises a user to place his or her finger on the finger print sensor. At step 1004, the remote computer detects whether a representation of a fingerprint has been received. If not, the remote computer continues to display the welcome message at step 1002.

Otherwise, the remote computer proceeds to step 1006. Here the remote computer transforms the representation of the fingerprint and performs any pre-processing calculations.

Next, the user is prompted to enter an ID at step 1008. Specifically, the remote computer displays a message directing them to enter an ID.

Then, at step 1008, the ID is used to select a record in the database of user information. The pre-processed fingerprint data is compared with the associated record data. If this generates a match the process proceeds to step 1012. The match process, however, may fail for one of two reasons. First, the user ID may not exist in the database. In this case, an error message is presented advising the user that the ID does not exist at step 1010. Second, the fingerprint may not generate a match. In this case, an error message is presented advising the user that the fingerprint does not match at step 1010. From there, the process returns to the welcome message at step 1002.

Returning to step 1012, if the comparison generates a match, then the remote computer polls the central server to determine whether the user has any messages waiting. If so, the central computer transmits the message(s) to the remote computer for display to the user at step 1012.

Simultaneous to the step of checking for messages, the remote computer also determines whether the user has access privileges to the associated access point at the current time. If not, at step 1018, the remote computer displays a message advising the user as to the reason access has been denied. That is, the user does not have access to the associated access point, or the user does not have access privileges at the current time.

Otherwise, at step 1016, the remote computer unlocks the associated access point to permit passage by the user. The remote computer then returns to the starting state at step 1002.

Although this process has been described as implemented on a central server, other implementations would be possible. For example, in a stand-alone system that is not implemented on a network, the user data could be entered directly into a computer-based user interface.

Likewise, although the security system has been described using a fingerprint sensor to obtain the biometric feature, other sensors could be used. For example, a camera configured to detect an iris pattern in a human eye or the features of a face.

Those skilled in the art will appreciate that many other variations and modifications may be made to the embodiments that have been described without departing from the scope of the invention. All such variations and modifications are intended to be included by the following claims.

We claim:

1. A security system comprising:
an administration unit configured to generate a database of biometric features and user ID's each associated with a specific person, wherein the administration unit includes:
a first input configured to capture a representation of a biometric feature and to generate a first electronic representation of the biometric feature;
a second input configured to receive a user ID; and
a computer processor operationally coupled with the first and second inputs and configured to save the first electronic representation of the biometric feature and the user ID in the database, wherein the biometric feature is associated with the user ID; and
a control unit operationally coupled with the administration unit and configured to control an access device, wherein the control unit includes:
a first input configured to capture a representation of the biometric feature and to generate a second electronic representation of the biometric feature;
a second input configured to receive a character string; and
a computer processor operationally coupled with the first and second inputs and with the database and configured to compare the second electronic representation of the biometric feature with the database of biometric features and to determine whether the comparison generates a biometric match, and to compare the character string with the database of user ID's to determine whether the comparison generates a user ID match.

2. The security system of claim 1, further comprising an auxiliary unit operationally coupled with the control unit, wherein the auxiliary unit and the control unit are situated on opposite sides of an access point, wherein the auxiliary unit includes:
a first input configured to capture a representation of the biometric feature and to generate a third electronic representation of the biometric feature; and
a second input configured to receive a character string; and
wherein the first and second inputs of the auxiliary unit are operationally coupled with the computer processor of the control unit, and wherein the computer processor of the control unit is configured to compare the third electronic representation of the biometric feature with the database of biometric features to determine whether the comparison generates a biometric match, and to compare the character string with the database of user ID's to determine whether the comparison generates a user ID match.

3. The security system of claim 2, wherein the biometric feature comprises a fingerprint.

4. The security system of claim 2, wherein the biometric feature comprises features of the human face.

5. The security system of claim 2, further comprising the access device, wherein the access device releases when the computer processor of the control unit detects the biometric match and the user ID match.

6. The security system of claim 5, wherein the detection of the biometric match and the user ID match are based upon data received from the first and second input of the control unit.

7. The security system of claim 5, wherein the detection of the biometric match and the user ID match are based upon data received from the first and second input of the auxiliary unit.

8. The security system of claim 5, wherein the access device comprises an electric circuit configured to control a magnetic field.

9. The security system of claim 1, further comprising:
a plurality of control units each operationally coupled with the administration unit and configured to control an access device; and
a plurality of auxiliary units each operationally coupled with one of the plurality of control units, wherein the auxiliary unit and the control unit pairs are situated on opposite sides of an access point.

10. A security system especially suited for controlling access within a building having a limited number of access points each having an interior side and an exterior side comprising:
a plurality of locking mechanisms each associated with one access point and configured to prevent passage through the access point in a closed position and to permit passage through the access point in an open position;
a plurality of interior user interfaces each associated with one access point and configured to generate a representation of a biometric feature and to receive a user ID from a user;
a plurality of exterior user interfaces each associated with one access point and configured to generate a representation of a biometric feature and to receive a user ID from a user;
a computer server having a database of user information including a plurality of records each of which includes a representation of a biometric feature, and a user identification; and
a plurality of local computers each associated with one access point and operationally coupled with the associated interior user interface and the exterior user interface and operationally coupled through a network connection to the computer server, wherein each one of the plurality of local computers controls the locking mechanism associated with the same access point and wherein each of the plurality of local computers are positioned on an interior side of the associated access point.

11. The security system of claim 10, wherein each of the plurality of locking mechanisms comprise a coil configured to pass an electric current that generates a magnetic field in the closed position.

12. The security system of claim 10, wherein each of the plurality of interior user interfaces comprises:
a touch screen configured to present messages to a user and to receive the user ID from the user; and
a fingerprint sensor configured to generate the representation of the biometric feature.

13. The security system of claim 10, wherein each of the exterior user interfaces comprises:
a keypad configured to receive the ID from the user; and
a fingerprint sensor configured to generate the representation of the biometric feature.

14. The security system of claim 10, wherein each of the plurality of records stored in the database of the computer server further include defined access privileges.

15. The security system of claim 10, wherein the computer server further includes a database of time records each associated with a user identification, wherein the time records detail the time in and time out of each user.

16. The security system of claim 10, wherein each of the plurality of local computers comprises a database of user information including a record for each authorized user that includes a representation of a biometric feature and an ID.

17. The security system of claim 16, wherein each of the plurality of local computers are configured to open the associated locking mechanism when the biometric feature and the user ID received from either of the associated interior or exterior user interfaces generates a match with the database of user information stored on the local computer.

18. The security system of claim 17, wherein the database of user information stored on the local computer is a copy of the database of user information on the server computer.

19. The security system of claim 10, wherein each of the plurality of local computers are configured to receive time in commands and time out commands from a user and to transmit a user identification to the computer server in response to such commands.

20. A method of operating a security system comprising the steps of:
establishing a central database of user information including records each having a representation of a biometric feature, a user ID and access privileges for each user;
transferring the user information from a central computer to a plurality of remote computers each having a display, a keypad interface and a biometric sensor;
receiving a representation of a biometric feature and a user ID from a user at one of the remote computers;
comparing the biometric feature and the user ID received from the user to the user information at the remote computer;
presenting a unique message addressed to the user ID; and
unlocking an access mechanism when the biometric feature and the user ID received from the user matches one of the records in the user information at the remote computer.
